(19) United States
(12) Patent Application Publication
(10) Pub. No.: US 2006/0259424 A1
(43) Pub. Date: Nov. 16, 2006

(54) Systems and methods for purchasing goods and collecting donations

(75) Inventors: Suzanne Turcotte, Providence, RI (US); William Turcotte II, Lafayette, CO (US)

Correspondence Address: EDWARDS & ANGELL, LLP, P.O. BOX 55874, BOSTON, MA, 02205, US

(73) Assignee: One Good Call, Inc.

(21) Appl. No.: 11/365,568

(22) Filed: Mar. 1, 2006

Related U.S. Application Data
(60) Provisional application No. 60/658,285, filed on Mar. 2, 2005.

(51) Int. Cl. G06Q 40/00

(52) U.S. Cl. 705/40

(57) ABSTRACT

A method of purchasing goods or services over a network including the steps of providing an interactive recording system on the network, receiving one or more communications from a device associated with a user seeking to purchase said goods or services via the interactive recording system, providing a purchase order to a merchant offering said goods or services and billing the user for each purchase of said goods or services, wherein the step of billing the user includes including a cost for said goods or services on a billing mechanism.

### CROSS-REFERENCE TO RELATED APPLICATION

This application claims priority to U.S. Provisional Patent Application No. 60/658,285, filed Mar. 2, 2005, which is incorporated herein by reference.

### BACKGROUND OF THE INVENTION

1. Field of the Invention

The present disclosure relates, in general, to providing and managing a telecommunication system that allows for purchasing and collecting monies for the sale of goods or services; making and collecting donations to charitable organizations, non-profit organizations, fund-raising organizations; making and collecting contributions to a medical or health care center; making and collecting contributions to medical and health care expenses of others; and the like via the user's telecommunication device. More particularly, the present invention relates to software, systems, and methods that allow a user to purchase goods or service, to donate money to a charitable organization, non-profit organization, fund-raising organization, to contribute money to a medical or health care center, to contribute to the medical and health care expenses of others, and the like electronically over a telecommunication network using the user's telecommunication device and, further, to billing the transaction amount, donation, contribution, and the like directly to an associated billing system or mechanism, e.g., the user's telephone, Internet Service Provider (“ISP”), and/or cable billing statement.

In addition, the present disclosure relates to systems that integrate calling technology, data downloading, validating data, and billing a user via a telecommunication device in such a way that the user can call an identified number and automatically purchase goods or services; donate to a charitable organization, non-profit organization, fund-raising organizations; make a contribution to a medical or health care facility, contribute to the medical or health care costs of others; and the like in a one-step process that is billed directly to an associated billing system or mechanism, e.g., the user's telephone, Internet Service Provider (“ISP”), and/or cable billing statement.

Furthermore, according to the present disclosure, a user can call an identified number that allows the user to leave a voice mail message for a predetermined charge or fee, which likewise would be billed directly to an associated billing system or mechanism, e.g., the user's telephone, Internet Service Provider (“ISP”), and/or cable billing statement. A percent of such charge could go to an identified charitable organization, non-profit organization, fund-raising organization, health care institution or the like. The present invention, further, can collect and consolidate such monies for the merchant, charitable organization, medical or health care facilities, and the like to allow for a lump sum payment directly to the merchant, charitable organization medical or health care facilities, and the like.

2. Background of the Relevant Art

Consumers and donors desire to complete a transaction, e.g., purchase goods or services and/or donate or contribute to organizations or persons in need, over a public switched telephone network (“PSTN”), cellular telephone network, wireless telephone network, and the like quickly and without the security concerns of providing unsecured credit card information and other payment information over the telephone. Consumers and donors also prefer to spare themselves the time and cost associated with providing such information and making immediate payment.

Telephonic transactions, as currently structured, require charitable organizations and businesses, e.g., merchants, or third party organizations working on behalf of the charitable organizations and merchants to collect consumer information related to billing and shipping as well as to collect payment information from donors or customers manually. Furthermore, charitable organizations, some businesses or third parties working on their behalf must also attend to collecting the related monies, which adds additional overhead, expense, and delay, which reduce net profit or proceeds. Although the Internet has automated such transactions in some areas, there is still a great deal of manual labor and administrative costs involved in the process.

For example, automated pay-per-call users are billed as telephone calls on leased phone lines. However, with automated pay-per-call systems there are no data downloads, no collection collations, and, further, the consumer has no ability to purchase products without entering a credit card number and providing personal information to an employee and/or a third party over the telephone.

Short Message Service (“SMS”) provides text messaging between users on a common mail server. Typically, SMS providers charge users for typed-in messages by the line. However, to receive and send messages requires users at both ends of the communication message need to subscribe to a common SMS provider.

### SUMMARY OF THE INVENTION

In contrast, the current disclosure does not require an Internet service or entering a message by typing a message. Indeed, with the present disclosure both the consumer/donor and the merchant/charitable organization benefits from secure and fast systems and methods whereby the consumer/donor can purchase goods or services and/or donate or contribute monies with a single telephone call and, in one embodiment, with a single push of a button on the telecommunication device. As a result, merchants and charitable organizations or third parties working on their behalf can reduce costs associated with the current method of telephone purchases and telephone donations. By also including the cost of the purchase, donation, and/or contribution to an associated billing system or mechanism, e.g., the user's telephone, Internet Service Provider (“ISP”), and/or cable billing statement, merchants, charitable organization, and other institutions do not have to pay a portion of the purchase, contribution or donation amount to a credit card provider or have to collect and process payment from the consumer/donor.

The present disclosure is directed to removing the burden of both from the consumers/purchasers and donors and the merchant and charitable organization groups and, further, streamlining the process of telephone purchases and donations into an automated process.

The present disclosure recognizes the tremendous amount of time and money that are spent verifying, securing, collecting, and collating monies from purchases, donations, contributions, and the like made over a telephonic communication, or “telecommunication” network. Not only does the present technology automatically verify, collect, and collate payments, donations, contributions, and the like, it also eliminates the security concerns and costs associated with a credit card.

Briefly stated, the present technology involves services, systems, and methods for managing and verifying billing data to create an automatic process to purchase goods or services; to donate to charitable organizations, non-profit organizations, fund-raising organizations; to make a contribution to the medical and health care costs of another, and the like using a telecommunication device whereby the amount of the purchase price, donation, and/or contribution is billed directly and automatically to an associated billing system or mechanism, e.g., the user's telephone, Internet Service Provider (“ISP”), and/or cable billing statement.

It should be appreciated that the present invention can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

The invention will be better understood by reference to the following more detailed description and accompanying drawings where like reference numbers refer to like parts:

FIG. 1 is a block diagram of an illustrative embodiment of a system for purchasing goods and services via a telecommunication network in accordance with the present invention;

FIGS. 2A-C are a flow chart of an illustrative embodiment of a method for purchasing goods and services via a telecommunication network in accordance with the present invention, wherein matching bubbles 2B-2B and 2C-2C illustrate how to properly connect FIGS. 2A-C;

FIG. 3 is a flow chart of an another illustrative embodiment of a method for purchasing goods and services via a telecommunication network in accordance with the present invention, wherein matching bubbles 2B-2B illustrate how to properly connect FIGS. 2A and 3;

FIG. 4 is a block diagram of an illustrative embodiment of a system for collecting donations via a telecommunication network in accordance with the present invention;

FIGS. 5A-C are a flow chart of an illustrative embodiment of a method for collecting donations via a telecommunication network in accordance with the present invention, wherein matching bubbles 5B-5B and 5C-5C illustrate how to properly connect FIGS. 5A-C;

FIG. 6 is a flow chart of an illustrative embodiment of a method for collecting donations via a telecommunication network in accordance with the present invention, wherein matching bubbles 5B-5B illustrate how to properly connect FIGS. 5A and 6;

FIG. 7 is a block diagram of an illustrative embodiment of a system for contributing to the medical and health care expenses of another and/or providing a voice message to the same via a telecommunication network in accordance with the present invention; and

FIG. 8 is a flow chart of an illustrative embodiment of a method for providing a voice message to a recipient in a health care institution.

### DETAILED DESCRIPTION OF PREFERRED EMBODIMENTS

The present invention provides systems and methods for completing a purchase; for enabling and collecting donations; for contributing to others or institutions over a telecommunication network. Although only four embodiments of the present invention will be presented in this disclosure, the invention is not to be construed as being so limited. Rather, the three embodiments are provided illustratively to show specific usage of the invention. Those skilled in the art would be able to apply the teachings of the embodiments to a myriad of systems and methods, all of which are within the scope and spirit of this disclosure.

Moreover, the illustrated embodiments can be understood as providing exemplary features of varying detail of certain embodiments, and therefore, unless otherwise specified, features, components, modules, elements, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and unless otherwise specified, can be altered without materially affecting or limiting the disclosed technology.

The flow charts herein illustrate the structure or the logic of the present technology, possibly as embodied in computer program software for execution on a computer, digital processor or microprocessor. Those skilled in the art will appreciate that the flow charts illustrate the structures of the computer program code elements, including logic circuits on an integrated circuit, that function according to the present technology. As such, the present invention is practiced in its essential embodiment(s) by a machine component that renders the program code elements in a form that instructs a digital processing apparatus (e.g., computer) to perform a sequence of function step(s) corresponding to those shown in the flow charts.

These three illustrative applications greatly reduce the current cost associated with interacting with donors and/or customers, and, further, reduce costs associated with data entry requirements in connection with donations, contributions, and/or purchase of goods or services over a telecommunication network. Advantageously, successful and timely collections of related monies will increase; expenses and fees related to credit card purchases will be eliminated; and consumers or donors who, otherwise, for security reasons, normally would not use a credit card to make a donation or contribution or purchase goods or service via a telecommunication network will now be more inclined to do so.

In a first embodiment, the present technology is directed to systems and methods for completing a sales transaction, e.g., a purchase, over a telecommunication network, e.g., a PSTN, a cellular telephone network, a wireless telephone network, and the like. Preferably, this purchasing system is best suited for merchants offering goods or service for sale via television, satellite television, cable television, and the like, and/or catalog-based merchants. However, the invention is not to be limited to this use.

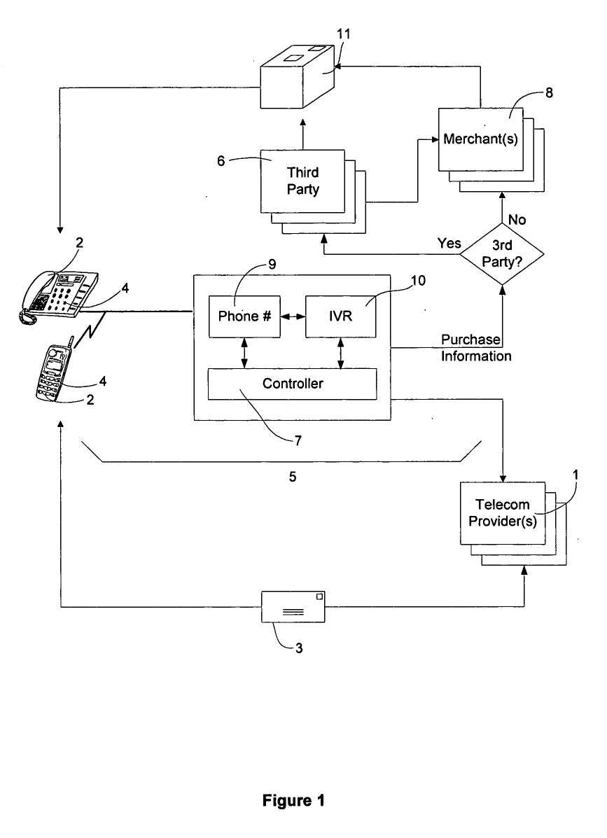

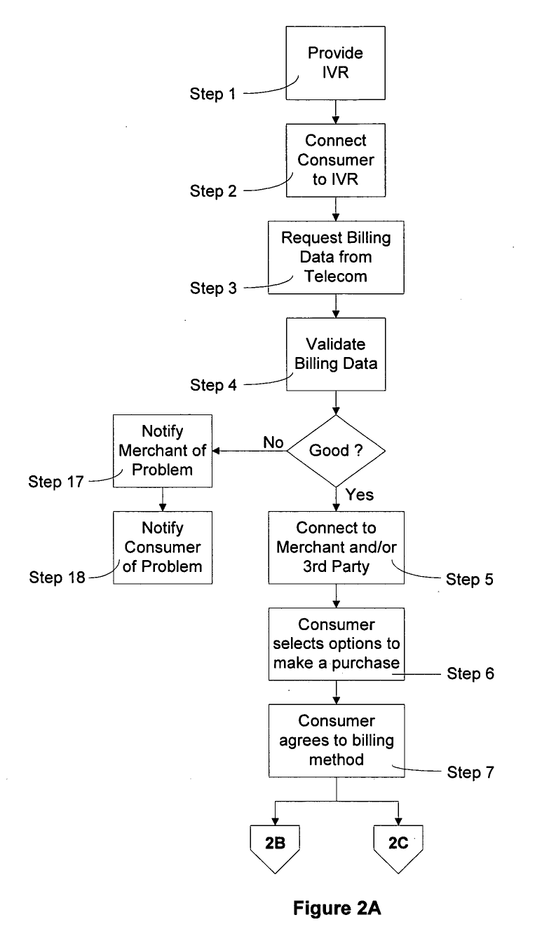

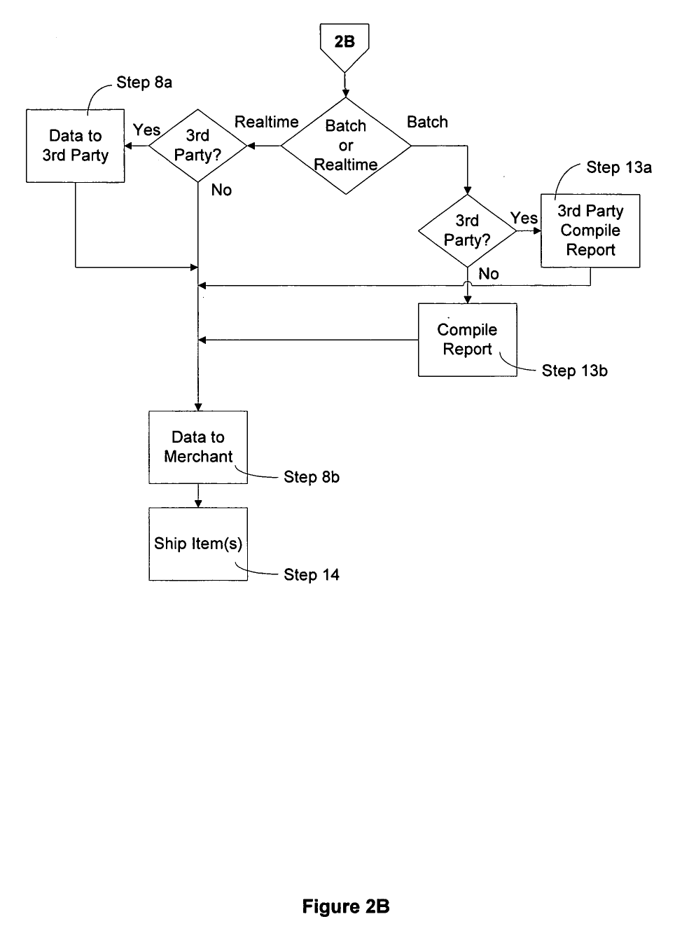

FIGS. 1 and 2A-C, respectively, provide an illustrative embodiment of a system for and a method of purchasing goods or services over a telecommunication network 5. Referring to FIG. 1, merchants 8 or third parties 6 provide one or more dedicated destination telephone numbers 9 that is/are in communication with and controlled by an interactive voice response (“IVR”) system 10 or by a separate controller 7 provided for that purpose. IVR systems 10 and controllers 7 for the same are well known to the art and will not be described in detail herein.

Preferably, the IVR system 10 and/or controller 7 includes applications, e.g., driving programs, software or the like, and storage memory to validate the calling telephone number and to prompt consumers/purchasers to enter a good or service (“item”) identification (“ID”) code, which has been provided beforehand in a catalog, advertisement, and the like. In a specific embodiment, a single telephone number can be dedicated to a single item and the consumer/purchaser can complete the transaction by pressing a single button on a telecommunication device input system 4, e.g., a keypad, or, alternatively, by uttering a single word or phrase using the microphone of the telecommunication device 2.

More particularly, using a telecommunication device input system 4, e.g., a keypad or a microphone, of a telecommunication device 2, customers/purchasers can manually or orally enter the item ID code. Further prompting by the IVR system 10 can include information about quantity, desired features (e.g., color, model, personalization, and the like), method of delivery (e.g., U.S. Postal Service, express overnight service, and the like). Customers/purchasers can enter their responses to these further prompts using the same telecommunication device input system 4.

Upon verification (which is discussed in greater detail below), the entered information, e.g., item ID code, quantity, shipping information, method of delivery, and the like, is then communicated directly or indirectly to the merchant 8, e.g., via electronic purchase order. Preferably, the merchant 8 or a third party 6 acknowledges receipt of the purchase order to the consumer/purchaser and ships the goods 11 to the billing address associated with the consumer's/purchaser's telecommunication device 2, i.e., telephone, cellular telephone, and the like. Although the preferred shipping address is the billing address associated with the consumer's/purchaser's telecommunication device 2, this is not to say that an address other than the billing address associated with the consumer's/purchaser's telecommunication device 2 cannot be used. However, to minimize the number of prompts and corresponding input of information that are required, which, if excessively long, can cause some potential consumers/purchasers to abort a transaction prior to completion, it is preferred that the good(s) is/are shipped or the service(s) is/are sent to the billing address associated with the consumer's/purchaser's telecommunication device 2.

The purchase price of the item and any related charges will later appear on an associated billing system or mechanism, e.g., the customer's/purchaser's telephone billing statement 3 that is issued by the customer's/purchaser's telecommunication provider 1. For simplicity, however, throughout the remainder of this disclosure, reference will only be made to a telephone billing statement as associated billing system or mechanism. The invention is not to be so construed as being so limited. Indeed, in addition to a customer's/purchaser's telephone billing statement, the billing system or mechanism can include (without limitation) the customer's/purchaser's ISP billing statement, customer's/purchaser's cable billing statement, and the like, all of which are within the scope and spirit of this invention.

Preferably, the telephone billing statement will include a description of the item(s) purchased, the purchase amount, the date of the transaction, and any invoice and/or confirmation number. The telecommunication service provider 1 used by the consumer/purchaser collects the purchase amount from the consumer/purchaser and remits payment to the merchant 8 or a third party 6. In the case of the latter, the third party 6 will subsequently remit payment to the merchant 8.

In a preferred embodiment, a real-time interface exists between the consumer/purchaser, the telecommunication provider 1, and the merchant 8. The telecommunication provider 1 is the billing agent for the merchant 8. Optionally, and more preferably, a third party 6 provides real-time reporting of purchases to the merchant 8 as they occur or, alternatively, provides the merchant 8 with a batch-type report that periodically, e.g., twice a day, nightly, etc., resolves the day's purchases. Third parties 6 can also track purchases related to consumers/purchasers calling the designated destination telephone number 9 to purchase the item(s) from the merchant 8 and provide an audit and customer reporting mechanism to the merchant 8. If there is no third party 6, then the merchant 8 maintains its own accounting of purchases, etc.

Referring to FIGS. 2A-C, a method of completing a purchase of goods or services over a telecommunication network will now be described. As provided immediately above, the method can include a real-time interface or a batch-type interface between the system and a telecommunication provider on one hand and the merchant and/or a third party on the other.

The first step of the method is to provide an interactive recording system (“IVR”) as described in greater detail above (STEP 1). Preferably, the IVR is in communication with a destination telephone number that, preferably, is uniquely dedicated to a specific item. More preferably, the IVR includes a controller or is separately controlled by a controller to perform the steps described hereinafter. Through advertising, e.g., television, newspaper, catalogs, and the like, the dedicated destination telephone number and the items corresponding to the dedicated destination telephone number can be published.

When a consumer/purchaser desires to purchase one or more of the items associated with the destination telephone number, he or she establishes a communication link with the IVR, e.g., by dialing the dedicated destination telephone number. Once the consumer/purchaser dials the dedicated destination telephone number, he or she is connected to the IVR (STEP 2).

Using the consumer's/purchaser's telephone number, the controller in the IVR or a separate controller identifies the calling number of the consumer/purchaser and requests that the telecommunication provider associated with the consumer/purchaser provide the consumer's/purchaser's billing address information (STEP 3). This billing address information is then validated (STEP 4) to ensure that if it is registered to an individual and otherwise not subject to a block that has been established to deny the consumer/purchaser the ability to make a purchase. Once the consumer's/purchaser's telephone number is validated, communication between the specific IVR, the consumer/purchaser, the merchant, and, optionally, a third party necessary to complete a purchase will be established (STEP 5).

Although the first and subsequent embodiments disclose that the IVR and/or the separate controller request consumer's/purchaser's billing address information from the consumer's/purchaser's associated telecommunication provider, the invention is not to be limited thereto. In addition to the other associated billing systems and mechanisms mentioned previously, a third party totally unrelated to the consumer/purchaser could use generally available data to identify the consumer's/purchaser's billing address information. For example, a third party could use a reverse telephone look-up search engine to determine the name and address of the caller.

The IVR and/or separate controller will then guide the consumer/purchaser through a short series of options that will enable them to purchase one or more of the items for a predetermined price (STEP 6). In a preferred embodiment, the offer to purchase can involve activation of a single key on an input device associated with the consumer's/purchaser's telecommunication device keypad or, alternatively, utterance of a single word or phrase over the microphone of the consumer's/purchaser's telecommunication device, to complete the transaction. Additional prompts can be included, however, to provide further options to the consumer/purchaser, e.g., to select a particular color, to select a method of delivery, to personalize the purchase, and the like. Thus, those skilled in the art will understand that the invention includes activation of one or more than one keys or, alternatively, utterance of one or more than one word.

Once the consumer/purchaser has input his or her response to all of the prompts and the IVR and/or separate controller has received the same, the IVR or a separate controller will prompt the consumer/purchaser to confirm that the consumer/purchaser agrees to have the amount of the purchase added to his or her telephone billing statement (STEP 7). Once confirmation/approval is received, the IVR or controller will thank the consumer/purchaser and the connection between the consumer/purchaser and the IVR can be terminated.

The IVR or separate controller then communicates a record of the transaction, including, but not limited to, the item ID code, the quantity, the time and date of the transaction, the consumer's/purchaser's telephone number, the consumer's/purchaser's shipping information, and the like, to the merchant directly (STEP 8b) and/or indirectly through a third party (STEP 8a). If the record of the transaction is first sent to a third party, then the third party will create an electronic purchase order that includes (without limitation) the item ID code, the quantity, and billing and shipping information, and send the purchase order to the merchant (STEP 8b). The merchant can then ship the item(s) purchased to the consumer/purchaser.

Preferably, the IVR or the controller also re-establishes a communication link with the telecommunication provider, e.g., the telecommunication provider's billing server, and provides the telecommunication provider with the amount of the purchase and any other transaction information, e.g., an invoice number or purchase confirmation number, (STEP 9) to be included on the consumer's/purchaser's next bill. The telecommunication provider then adds the purchase and transaction information to the consumer's/purchaser's next billing statement (STEP 10). When paid, the telecommunication provider will remit payment either to the merchant directly (STEP 11b) or indirectly through a third party (STEP 11a). Although re-establishing communication with the telecommunication provider is preferred, because the nature of the transaction minimizes the time of the transaction, communication between the IVR or the controller and the telecommunication provider does not have to be terminated after the telecommunication provider initially provides the consumer's/purchaser's billing address information at STEP 4.

Having described a real-time interface embodiment in which communication between the IVR or the controller and the merchant is established for each and every transaction in real-time, a batch-type embodiment will now be described. In contrast with real-time interfacing, batch-type interfacing allows multiple transactions from multiple consumers/purchasers to accumulate in memory provided for that purpose. The memory can reside with the controller and/or with a third party. Accordingly, interfacing with the merchant is made periodically at a predetermined interval(s) or time(s) of the day, e.g., hourly, nightly at close of business, twice a day, etc.

STEPS 1-7 of a batch-type embodiment are identical to STEPS 1-7 of the real-time embodiment described immediately above. In contrast, however, after completion of STEP 7, instead of being transmitted to the merchant, the data are stored in memory associated with the third party or with the controller for a period of time. If the records of the transactions are stored in a memory associated with the third party, then the third party will create a compiled electronic purchase order (STEP 13a) that includes (without limitation) the item ID code, the quantity, the time and date of the transaction, the consumer's/purchaser's telephone number, the consumer's/purchaser's shipping information, and the like, and send it to the merchant (STEP 8b) collectively in a batch. Alternatively, if the records are stored in a memory associated with the controller, then, at a specified interval, all open purchase records of transactions, including, but not limited to, the item ID code, the quantity, the time and date of the transaction, the consumer's/purchaser's telephone number, the consumer's/purchaser's shipping information, and the like, will be compiled (STEP 13b) and the compilation communicated to the merchant (STEP 8b) collectively in a batch. The merchant can then ship the items purchased to the various consumers/purchasers (STEP 14).

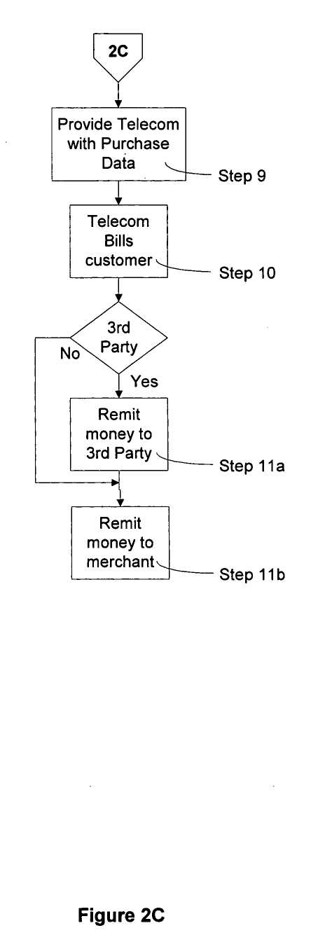

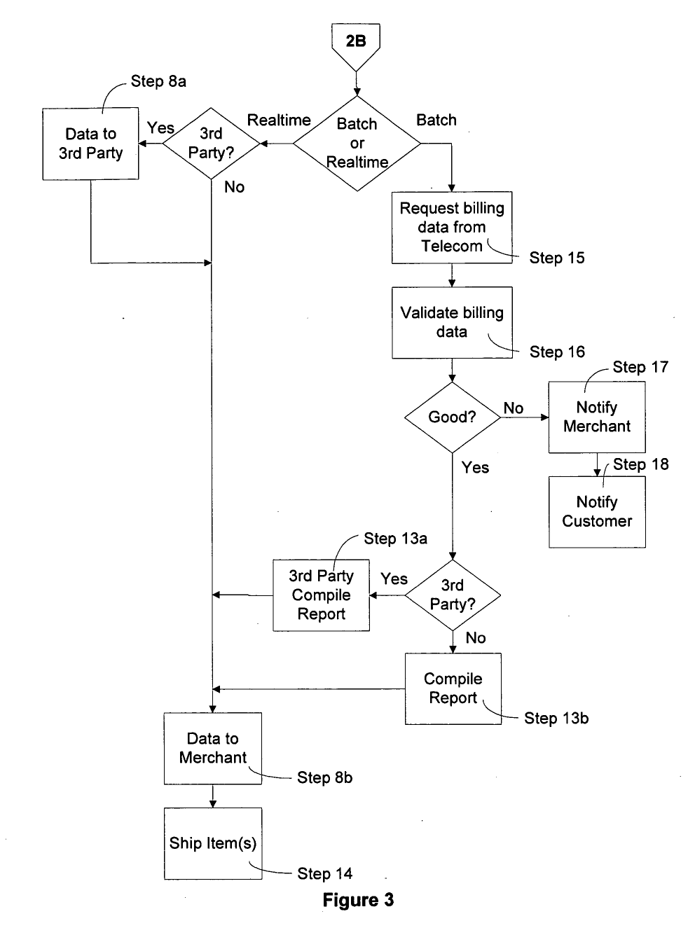

Referring to FIG. 3, a further modification to the batch-type embodiment will be described. According to this modified batch-type alternative, STEPS 3 and 4 of the first batch-type embodiment are not performed until after the specified interval and STEP 7. As a result, as with the first batch-type embodiment, the data, instead of being transmitted to the merchant immediately, will be stored with the third party or with the controller in memory provided for that purpose. Then, as described above, at a specified interval, all open purchase records will be communicated collectively to an appropriate destination.

At the occurrence of the specified interval, at least one of the third party, the IVR, and the separate controller requests that the telecommunication provider(s) associated with each of the consumers/purchasers whose purchase records remain open since the last specified interval provide the third party/IVR/controller with each consumer's/purchaser's billing address information (STEP 15). This billing address information will then be validated (STEP 16) to ensure that each is registered to an individual and not otherwise subject to a block that has been established to deny any consumer/purchaser the ability to make a purchase.

If the data are validated and the data were stored with the third party, then the third party will create a cumulative electronic purchase order (STEP 13a) that can include (without limitation) the item ID code, the quantity, and billing and shipping information for each consumer/purchaser, and send it to the merchant (STEP 8b). If, instead, the data were stored in a memory associated with the controller or the IVR, the controller or the IVR would create a cumulative electronic purchase order (STEP 13b) that includes (without limitation) the item ID code(s), quantities, and billing and shipping information for each consumer/purchaser, and the information will be transmitted to the merchant (STEP 8b). The merchant can then ship the items purchased to the various consumers/purchasers (STEP 14).

Any invalid record(s) will be removed and the merchant will be informed (STEP 17). The merchant or a third party can then provide notice to the consumer/purchaser of the canceled transaction (STEP 18).

In a second embodiment, the present technology is directed to systems and methods for donating or contributing to a charitable organization, a non-profit organization, a fund-raising organization, and the like, over a telecommunication network, e.g., a PSTN, a cellular telephone network, a wireless telephone network, and the like. These organizations further include certain institutions, including (without limitation) health care facilities, museums, art centers, historical monuments or sites, political parties, public action committees, universities or colleges, public service media, e.g., Public Broadcast Network or National Public Radio, and the like. For simplicity, hereinafter, the second application will be described for making a donation to a charitable organization. However, this is only for illustrative purposes and does not preclude donations or contributions to other than charitable organizations.

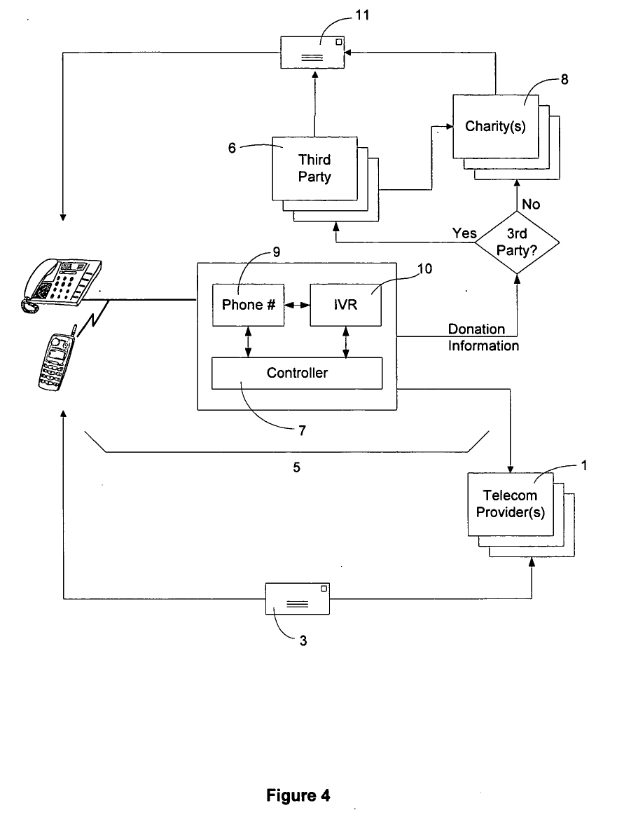

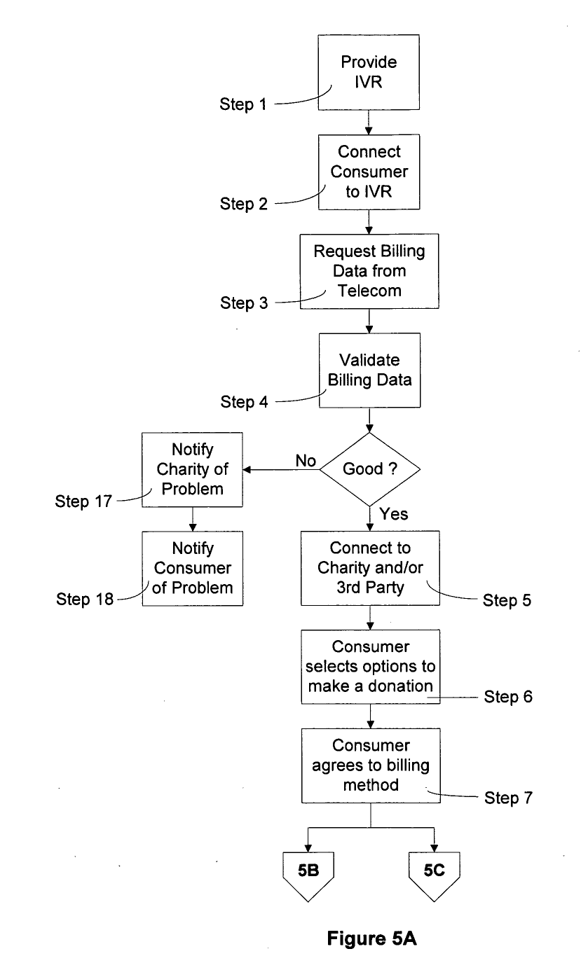

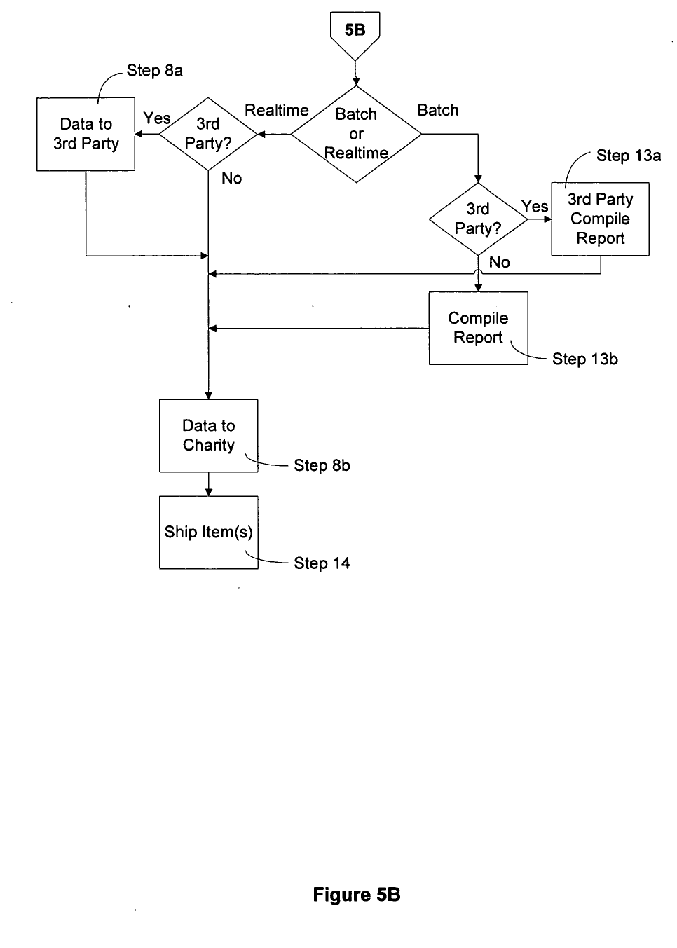

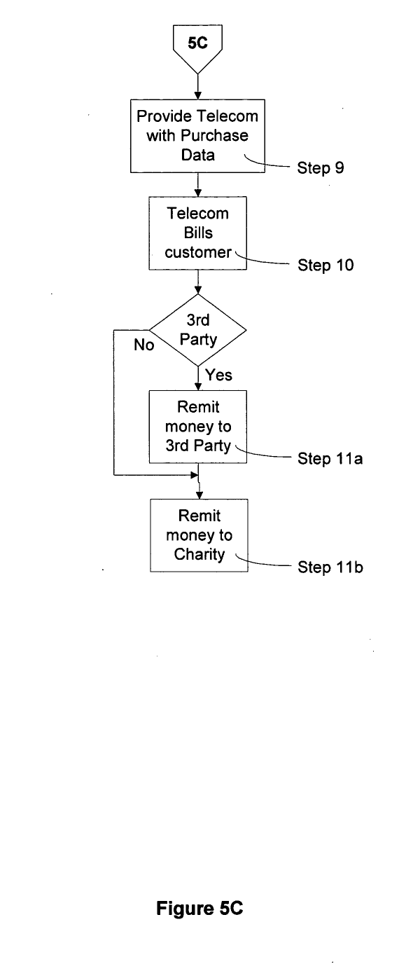

FIGS. 4 and 5A-C, respectively, also provide an illustrative embodiment of systems for and methods of donating monies to charitable organizations over a telecommunication network 5. Referring to FIG. 1, the charitable organization 8 or a third party 6 provides one or more dedicated destination telephone numbers 9 that is/are in communication with and controlled by an interactive voice response (“IVR”) system 10 or by a separate controller 7 provided for that purpose. IVR systems 10 and controllers 7 for the same are well known to the art and will not be described in detail herein.

Preferably, the IVR system 10 and/or controller 7 includes applications, e.g., driving programs, software or the like, and storage memory to validate the calling telephone number and to prompt donors to enter a donation amount. Preferably, the prompt is provided in a voice menu format that prompts the donor to, e.g., “Press or say 1 if you want to donate $100. Press or say 2 if you want to donate $200”, etc. In a specific embodiment, the donor can complete the donation by pressing a single button on a telecommunication device input system 4, e.g., a keypad, or, alternatively, by uttering a single word or phrase using the microphone of a telecommunication device 2. More particularly, using a telecommunication device input system 4, e.g., a keypad or a microphone, of a telecommunication device 2, donors can manually or orally enter the donation amount.

Upon verification (which is discussed in greater detail below), the entered information, e.g., amount of the donation, name and address of the donor, and the like is then communicated directly or indirectly to the charitable organization 8, e.g., via electronic message. Preferably, the charitable organization 8 or a third party 6 acknowledges receipt of the donation to the donor and provides the donor with a record of the donation. Although the preferred mailing address is the billing address associated with the donor's telecommunication device 2, this is not to say that an address other than the billing address associated with the donor's telecommunication device 2 cannot be used. However, to minimize the number of prompts and corresponding input of information that are required, it is preferred that the record of donation is shipped to the billing address associated with the donor's telecommunication device 2.

The donation amount will appear on an associated billing system or mechanism, e.g., the donor's next telephone billing statement 3 that is issued by the donor's telecommunication provider 1. As mention previously in our discussion of the first embodiment, reference is made only to a telephone billing statement as an associated billing system or mechanism; however, this is done for simplicity only.

Preferably, the telephone billing statement will include a description of the charitable organization, the donation amount, and the date of the donation. The telecommunication service provider 1 used by the donor collects the donation amount and remits payment to the charitable organization 8 directly or indirectly through a third party 6. In the case of the latter, the third party 6 will subsequently remit payment to the charitable organization 8.

In this preferred embodiment, a real-time interface exists between the donor, the telecommunication provider 1, and the charitable organization 8. The telecommunication provider 1 is the collecting agent for the charitable organization 8. Optionally, and more preferably, a third party 6 provides real-time reporting of donation to the charitable organization 8 as they occur or, alternatively, provides the charitable organization 8 with a batch-type report that periodically, e.g., twice a day, nightly, etc., resolves the daily or weekly donations. Third parties 6 can also track donors calling the destination telephone number 9 to make a donation and provide an audit and donor reporting mechanism to the charitable organization 8. If there is no third party 6, then the charitable organization 8 maintains its own accounting of donations, etc.

Referring to FIGS. 5A-C, a method of completing a donation over a telecommunication network will now be described. As provided immediately above, the method can include a real-time interface or a batch-type interface between the system and a telecommunication provider on one hand and the charitable organization and/or a third party on the other.

The first step of the method is to provide an interactive recording system (“IVR”) as described in greater detail above (STEP 1). Preferably, the IVR is in communication with a destination telephone number that is uniquely dedicated to a specific charitable organization. More preferably, the IVR includes a controller or is separately controlled by a controller to perform the steps described hereinafter. Through advertising, e.g., television, newspaper, radio, and the like, the dedicated destination telephone number and the charitable organization corresponding to the dedicated destination telephone number can be published.

When a donor desires to make a donation to the charitable organization associated with the destination telephone number, he or she establishes a communication link with the IVR, e.g., by dialing the dedicated destination telephone number. Once the donor dials the dedicated destination telephone number, he or she is connected to the IVR (STEP 2).

Using the donor's telephone number, the controller in the IVR or a separate controller identifies the calling number of the donor and requests that the telecommunication provider associated with the donor provide the donor's billing address information (STEP 3). This billing address information is then validated (STEP 4) to ensure that if it is registered to an individual and otherwise not subject to a block that has been established to deny the donor the ability to make a donation. Once the donor's telephone number is validated, communication between the specific IVR, the donor, the charitable organization and, optionally, a third party necessary to complete a donation will be established (STEP 5).

The IVR and/or separate controller will then guide the donor through a short series of options that will enable them to donate to a predetermined amount or an amount of their own choosing to one or more charitable organizations (STEP 6). In a preferred embodiment, the donation will involve activation of a single key on an input device associated with the donor's telecommunication device or, alternatively, utterance of a single word or phrase using the microphone of the donor's telecommunication device, to complete the donation. Additional prompts can be included, however, to provide further options to the donor, e.g., to make a donation to another charitable organization, to donate an amount of the donor's choosing, and the like.

Once the donor has input his or her response to all of the prompts and the IVR and/or separate controller has received the same, the IVR or a separate controller will prompt the donor to confirm that the donor agrees to have the amount of the donation added to his or her telephone billing statement (STEP 7). Once confirmation/approval is received, the IVR or controller will thank the donor and the connection between the donor and the IVR can be terminated.

The IVR or separate controller then communicates a record of the donation, including, but not limited to, the amount of the donation(s), the time and date of the donation(s), the donor's name and mailing address, and the like, to the charitable organization (STEP 8b) directly or indirectly through a third party (STEP 8a). If the record of the donation is first sent to a third party (STEP 8a), then the third party will subsequently create an electronic record of the donation(s) that includes (without limitation) the donation amount(s), the time and date of the donation(s), the donor's name and mailing address, and the like, and send it to the charitable organization (STEP 8b). The charitable organization or, optionally, the third party can then send, e.g., an expression of appreciation and record of the donation to the donor.

Preferably, the IVR or the controller also re-establishes a communication link with the telecommunication provider, e.g., the telecommunication provider's billing server, and provides the telecommunication provider with the amount of the donation and any other related donation information (STEP 9) to be included on the donor's next billing statement. The telecommunication provider then adds the donation and related donation information to the donor's next billing statement (STEP 10). When paid, the telecommunication provider will remit payment either to the charitable organization directly (STEP 11b) or indirectly through the third party (STEP 11a). Although re-establishing communication with the telecommunication provider is preferred, because the nature of the transaction minimizes the time of the donation, communication between the IVR or the controller and the telecommunication provider does not have to be terminated after the telecommunication provider provides the donor's billing address information at STEP 4.

Having described a real-time interface embodiment in which communication between the IVR or the controller and the charitable organization is established for each and every donation in real-time, a batch-type embodiment will now be described. In contrast with real-time interfacing, batch-type interfacing allows multiple donations from multiple donors to accumulate in memory provided for that purpose. The memory can reside with the controller and/or of the third party. Accordingly, interfacing with the charitable organization is made periodically at a predetermined interval(s) or time(s) of the day, e.g., hourly, nightly at close of business, twice a day, etc.

STEPS 1-7 of a batch-type embodiment are identical to STEPS 1-7 of the real-time embodiment described immediately above. In contrast, however, after completion of STEP 7, instead of being transmitted to the charitable organization, the data are stored in a memory associated with the third party or with the controller for a period of time. If the records of the donations are stored in a memory associated with the third party, then the third party will create a compiled electronic record of donation (STEP 13a) that includes (without limitation) the donation amount, the time and date of the donation, the name of the donor, and the donor's mailing information, and the like, and send it to the charitable organization (STEP 18b) collectively in a batch. Alternatively, if the records are stored in a memory associated with the controller, then, at a specified interval, all open records of donations, including, but not limited to, the amount of the donations, the time and date of the donations, the name of the donors, and each donor's mailing information, and the like, will be compiled (STEP 13b) and the compilation communicated to the charitable organization (STEP 8b) collectively in a batch. The charitable organization or, optionally, the third party, can then send, e.g., an expression of appreciation and record of the donation to the donor.

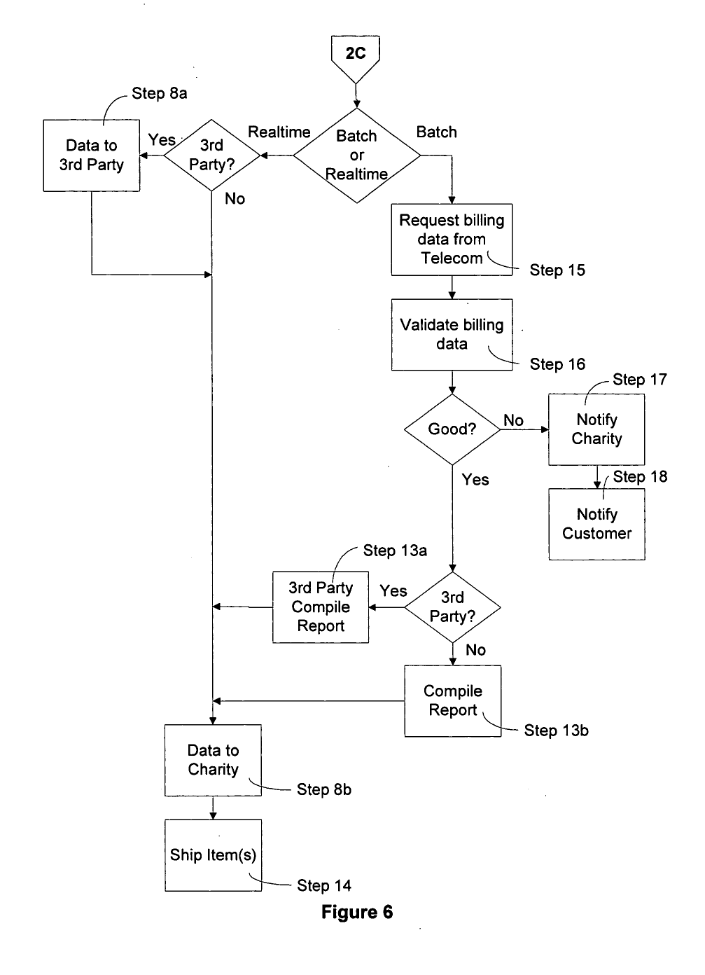

Referring to FIG. 6, a further modification to the batch-type embodiment will be described. According to this modified batch-type embodiment, STEPS 3 and 4 of the first batch-type embodiment are not performed until after the specified interval and STEP 7. As a result, as with the first batch-type embodiment, the data, instead of being transmitted to the charitable organization immediately, will be stored with the third party or with the controller in memory provided for that purpose. Then, as described above, at a specified interval, all open donation records will be communicated to an appropriate destination.

At the occurrence of the specified interval at least one of the third party, the IVR, and the controller requests that the telecommunication provider(s) associated with each of the donors whose record of donation remains open since the last specified interval provide the third party/IVR/controller with each donor's mailing address information (STEP 15). This mailing address information will then be validated (STEP 16) to ensure that it is registered to an individual and not otherwise subject to a block that has been established to deny the donor the ability to donate to a charitable organization.

If the data are validated and the data were stored with the third party, then the third party will create a cumulative electronic donation record (STEP 13a) that can include (without limitation) the amount of the donations, the time and date of the donations, the name of the donors, and each donor's mailing information, and the like, and send it to the charitable organization (STEP 8b). If, instead, the data were stored in a memory associated with the controller or the IVR, the controller or the IVR would create a cumulative electronic donation record (STEP 13b) that includes (without limitation) the amount of the donations, the time and date of the donations, the name of the donors, and each donor's mailing information, and the like, and the information will be transmitted to the charitable organization (STEP 8b). The charitable organization can then send, e.g., an expression of appreciation and record of the donation to the donor.

Any invalid donation record(s) will be removed and the charitable organization will be informed (STEP 17). The charitable organization or, optionally, the third party can then provide notice to the donor of the canceled donation (STEP 18).

In a third embodiment, the present invention discloses systems and methods for leaving voice mail messages and/or making donations to health care costs, e.g., to a person institutionalized or a patient awaiting a surgical operation (hereinafter collectively a “recipient”) in a hospital, medical center, health care institution, assisted living home, and the like (hereinafter, collectively the “health care institutions”), over a telecommunication network, e.g., a PSTN, a cellular telephone network, a wireless telephone network, and the like.

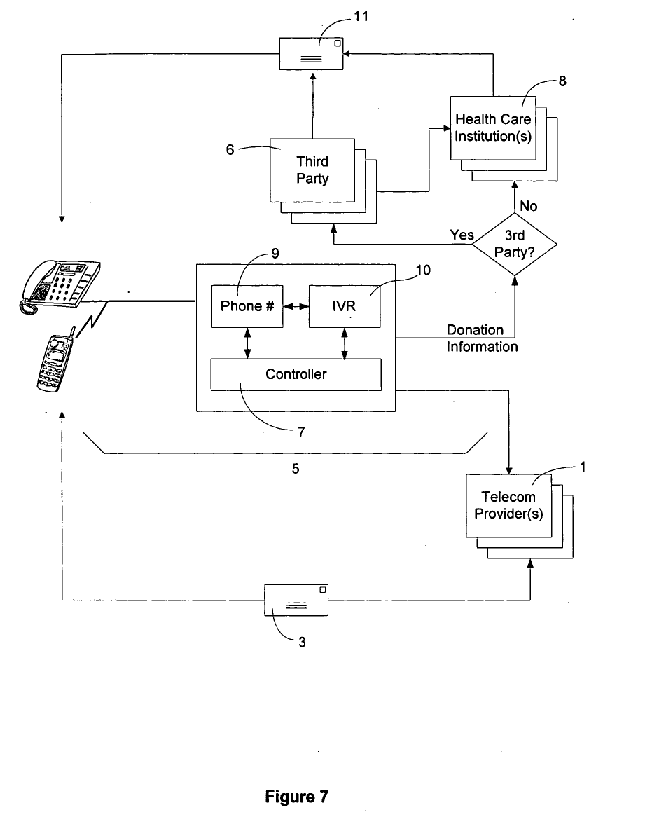

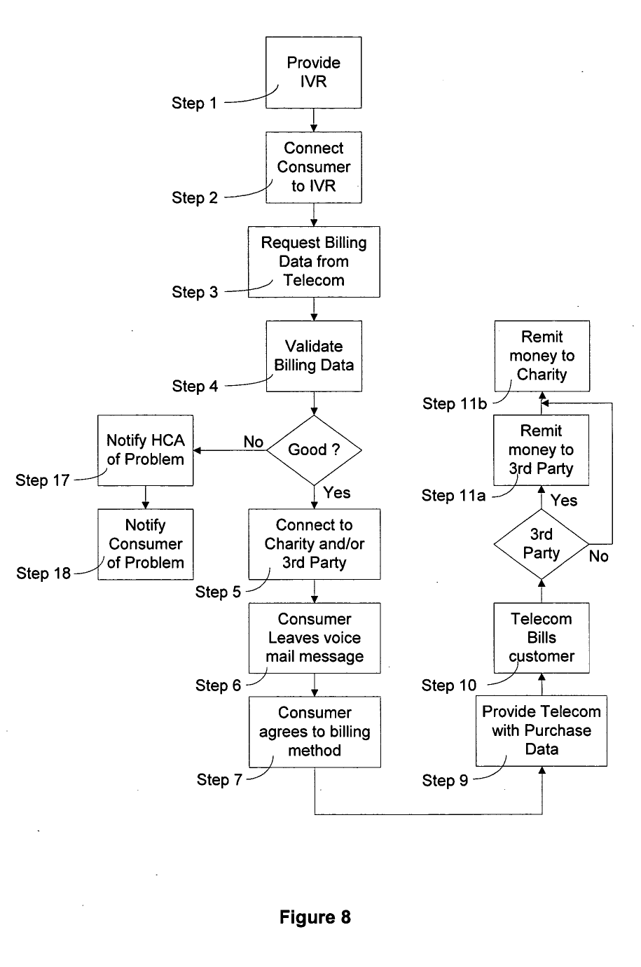

FIGS. 7 and 8, respectively, provide an illustrative embodiment of a system for and a method of leaving voice mail messages and/or contributions for health care costs to a recipient over a telecommunication network 5. Referring to FIG. 7, the health care institution 8 or a third parties 6 provides one or more dedicated telephone numbers 9 that is/are in communication with and controlled by an interactive voice response (“IVR”) system 10 or by a separate controller 7 provided for that purpose. IVR systems 10 and controllers 7 for the same are well known to the art and will not be described in detail herein.

Preferably, the IVR system 10 and/or controller 7 include applications, e.g., driving programs, software or the like, and storage memory to validate the calling telephone number and to prompt users to leave a voice mail message for the recipient and/or make a donation to the health care costs of a recipient. The entered information is then communicated to the health care institution 8 or, optionally, to a third party 6, for subsequent delivery to the recipient and/or credited to the recipient's medical billing statement.

A fee for recording a voice mail message and/or any donation to the recipient's health care costs will appear on the user's next telephone billing statement 3 originating from the user's telecommunication provider 1. Preferably, the telephone billing statement 3 will include an identification of the recipient, an identification of the health care institution, the date and time of the telephone call, the amount of the donation and/or fee, and the like. The telecommunication service provider 1 used by the user collects the fee and remits payment to the health care institution 8 or, alternatively, to a third party 6. In the case of the latter, the third party 6 will subsequently remit payment of the fee to the health care institution 8.

In this preferred embodiment, a real-time interface exists between the user, the telecommunication provider 1, and the health care institution 8. The telecommunication provider 1 is the collecting agent for the health care institution 8. Optionally, a third party 6 can provide real-time reporting of voice mail messages and donations for health care expenses to the health care institution 8 as they occur or, alternatively, provides the health care institution 8 with a batch-type report that periodically, e.g., twice a day, nightly, etc., provides a number of voice mail messages and a compiled listing of health care cost donations.

A method of collecting fees for providing a voice mail message service and for donating to the health care costs of a recipient over a telecommunication network will now be described. As provided immediately above, the method can include a real-time interface or a batch-type interface between the system and a telecommunication provider on one hand and the health care institution and/or a third party on the other. The steps pertaining to the donation portion of the process are similar to those described in detailed in connection with making a donation, i.e., the second embodiment, and will not be discussed further. Additional prompts, however, can be included to provide further options to the user, e.g., to make a donation of a predetermined amount to another patient in the same or another health care institution, to make a donation in an amount of the user's own choosing to recipient, and the like.

Referring to FIG. 8, the voice message portion of the method will be described. STEPS 1 through 5 are common to both the voice message portion and the donation portion of the method for both a real-time and a batch system. STEPS 8a and 8b, 13a and 13b, associated with the real-time or the batch system, and STEPS 17 and 18, associated with problems with validation, are not shown in FIG. 8 because the voice message portion of the embodiment does not depend on whether the method uses real-time or batch interfacing. Likewise, if during the validation step (STEP 4 or STEP 16) the user is invalidated in connection with the contribution portion of the embodiment, then the user would also be invalidated for the voice messaging portion of the embodiment.

The first step of the method is to provide an interactive recording system (“IVR”) as described in greater detail above (STEP 1). Preferably, the IVR is in communication with a destination telephone number that, preferably, is dedicated to a specific patient, i.e., the recipient, and a specific health care institution. More preferably, the IVR includes a controller or is separately controlled by a controller to perform the steps described hereinafter.

When a user desires to send a voice message to a recipient and/or make a contribution to the health care costs of a recipient in a health care institution, he or she establishes a communication link with the IVR, e.g., by dialing the dedicated destination telephone number. Once the user dials the dedicated destination telephone number, he or she is connected to the IVR (STEP 2).

Using the user's telephone number, the controller in the IVR or a separate controller identifies the calling number of the user and requests that the telecommunication provider associated with the user provide the user's billing address information (STEP 3). This billing address information is then validated (STEP 4) to ensure that if it is registered to an individual and otherwise not subject to a block that has been established to deny the user the ability to leave a voice mail message and/or to contribute to the health care costs of a recipient. Once the user's telephone number is validated, communication between the specific IVR and the user necessary to leave a voice mail message for a recipient and/or contribute to the health care costs of a recipient will be established (STEP 5).

The IVR and/or separate controller will then guide the user through a short series of options that will enable the user to leave one or more voice mail messages (STEP 6). Once the user has recorded his or her voice mail message and the IVR and/or separate controller has received the same (STEP 6), the IVR or a separate controller will prompt the user to confirm that the user agrees to have the fee for the voice mail message added to his or her telephone billing statement (STEP 7).

Preferably, the IVR or the controller re-establishes a communication link with the telecommunication provider, e.g., the telecommunication provider's billing server, and then acknowledges the user's agreement of the voice mail message fees (STEP 9). The telecommunication provider then adds the fees and related information, e.g., name of recipient, date of message, and the like, to the user's next billing statement (STEP 10). When paid, the telecommunication provider will remit payment for the messaging either to the health care institution directly (STEP 11b) or indirectly through the third party (STEP 11a). Although re-establishing communication with the telecommunication provider is preferred, because the nature of the transaction minimizes the time of the donation, communication between the IVR or the controller and the telecommunication provider does not have to be terminated after the telecommunication provider provides the user's billing address information.

As would be appreciated by those of ordinary skill in the pertinent art, the subject technology is not limited to telecommunications networks. In fact, the various components may be any known or later developed technology for communicating in a network (client/server and otherwise). For example, one or more digital data processing devices can be used as the components 1, 2, 6, 7, 8, 9, 10, and 11 in connection with various embodiments of the technology. Such devices generally can be a personal computer, computer workstation (e.g., Sun, HP), laptop computer, server computer, mainframe computer, handheld device (e.g., personal digital assistant, Pocket PC, cellular telephone, etc.), information appliance, or any other type of generic or special-purpose, processor-controlled device capable of receiving, processing, displaying, and/or transmitting digital data. A processor generally is logic circuitry that responds to and processes instructions that drive a digital data processing device and can include, without limitation, a central processing unit, an arithmetic logic unit, an application specific integrated circuit, a task engine, and/or any combinations, arrangements, or multiples thereof. Software or code generally refers to computer instructions which, when executed on one or more digital data processing devices, cause interactions with operating parameters, sequence data/parameters, database entries, network connection parameters/data, variables, constants, software libraries, and/or any other elements needed for the proper execution of the instructions, within an execution environment in memory of the digital data processing device(s). Those of ordinary skill will recognize that the software and various processes discussed herein are merely exemplary of the functionality performed by the disclosed technology and thus such processes and/or their equivalents may be implemented in commercial embodiments in various combinations and quantities without materially affecting the operation of the disclosed technology.

As is known to those of ordinary skill, a network can be a series of network nodes (each node being a digital data processing device, for example) that can be interconnected by network devices and communication lines (e.g., public carrier lines, private lines, satellite lines, etc.) that enable the network nodes to communicate. The transfer of data (e.g., messages) between network nodes can be facilitated by network devices such as routers, switches, multiplexers, bridges, gateways, etc. that can manipulate and/or route data from an originating node to a destination node regardless of any dissimilarities in the network topology (e.g., bus, star, token ring, etc.), spatial distance (local, metropolitan, wide area network, etc.), transmission technology (e.g., TCP/IP, Systems Network Architecture, etc.), data type (e.g., data, voice, video, multimedia, etc.), nature of connection (e.g., switched, non-switched, dial-up, dedicated, virtual, etc.), and/or physical link (e.g., optical fiber, coaxial cable, twisted pair, wireless, etc.) between the originating and destination network nodes.

Although preferred embodiments of the invention have been described using specific terms, such descriptions are for illustrative purposes only, and it is to be understood that changes and variations may be made without departing from the spirit or scope of the following claims.

What I claim is:

1. A method of purchasing goods or services over a network, the steps of the method comprising:
providing an interactive recording system on the network;
receiving one or more communications from a device associated with a user seeking to purchase said goods or services via the interactive recording system;
providing a purchase order to a merchant offering said goods or services; and
billing the user for each purchase of said goods or services,
wherein the step of billing the user includes including a cost for said goods or services on a billing mechanism.

2. A method as recited in claim 1, wherein the network is a telecommunications network.

3. A method as recited in claim 1, wherein the recording system records voice.

4. A method as recited in claim 1, wherein the communication is a telephone call.

5. A method of collecting donations over a telecommunication network, the steps of the method comprising:
providing an interactive voice recording system on the telecommunication network;
receiving one or more calls from a telecommunication device belonging to a donor seeking to donate money to a donee via the interactive voice recording system;
providing the donated money to the donee; and
billing the donor for each donation,
wherein the step of billing the donor includes including the amount of the donated money on a billing mechanism.

6. A system for donating money to a donee and purchasing goods or services from a source over a telecommunication network, wherein the system comprises:
a) an interactive voice recording system on the telecommunication network, wherein the interactive voice recording system receives i) one or more calls from a telecommunication device belonging to a user seeking to purchase said goods or services, and ii) one or more calls from a telecommunication device belonging to a donor seeking to donate an amount to the donee;
b) a donation disbursement device that disburses the amount of the donation to the donee;
c) a purchase order device that provides a purchase order to a merchant offering said goods or services; and
d) a billing device that i) bills the donor for each, and ii) donation bills the user for each purchase of said goods or services,
wherein the billing device includes i) the amount of the donation on a billing mechanism, and ii) a cost for said goods or services on a billing mechanism.
